(19) United States
(12) Patent Application Publication
(10) Pub. No.: US 2020/0250732 A1
(43) Pub. Date: Aug. 6, 2020

(54) METHOD AND APPARATUS FOR USE IN DETERMINING TAGS OF INTEREST TO USER

(71) Applicants: BEIJING JINGDONG SHANGKE INFORMATION TECHNOLOGY CO., LTD., Beijing (CN); BEIJING JINGDONG CENTURY TRADING CO., LTD., Beijing (CN)

(72) Inventors: Xingmei YU, Beijing (CN); Haiyong CHEN, Beijing (CN); Jiashuai SHAO, Beijing (CN)

(21) Appl. No.: 16/755,232

(22) PCT Filed: Sep. 27, 2018
(86) PCT No.: PCT/CN2018/107969

§ 371 Date: Apr. 10, 2020

(30) Foreign Application Priority Data
Oct. 12, 2017 (CN) 201710948881.3

(51) Int. Cl. G06Q 30/06; G06Q 30/02; G06F 40/284

(52) U.S. Cl. CPC G06Q 30/0631; G06F 40/284; G06Q 30/0201; G06Q 30/0641

(57) ABSTRACT

The present disclosure discloses a method and a device for determining an interest label of a user, which relates to the field of computer information processing. The method includes: obtaining word segmentation data by performing pre-processing on basic data; obtaining seed data by performing maximum frequent itemset identification on the word segmentation data; obtaining word vector data and word weight data by performing data training on the seed data; and determining the interest label of the user according to the word vector data and the word weight data.

### CROSS-REFERENCE TO RELATED APPLICATIONS

The present application is based upon International Application No. PCT/CN2018/107969, filed on Sep. 27, 2018, which is based upon and claims priority to Chinese Patent Application No. 201710948881.3 filed on Oct. 12, 2017, the entire contents of which are incorporated herein by reference.

### TECHNICAL FIELD

The present disclosure relates to the field of computer information processing, and in particular, to a method and a device for determining an interest label of a user.

### BACKGROUND

With popularization and promotion of online shopping, competition between shopping websites becomes more fierce. With sharp rise of e-commerce, in order to survive in long-term and stably, an enterprise firstly must attract users, and secondly needs to manage users, so that the users become loyal users of the enterprise. How to manage users well is a problem. With recording of user behavior data and maturity of data mining algorithm technology, the enterprise may manage users through various methods. How to push user's interesting product to the user in e-commerce is extremely important. In this process, identifying the user's interest is very important. Based on the identifying of the user's interest, precise marketing to the user is the cost common core, that is, a right product is recommended to right people at right time. To perform precise marketing, or sell, by a supplier, a product to right people, it needs to be realized by using user portraits. The user's interest label is an interest level showing how the user wants to buy a product of a certain category or brand, that is, the enterprise may recommend a suitable product to the user based on the user's interest label, and the supplier may target people who are interested in their products for marketing based on the interest label, so that enterprise/supplier and the user achieve a win-win situation.

There are various user interests. In different industries, the interests of the user that need to be paid attention to are different. The e-commerce industry focuses on the interests and hobbies that affect user's purchases. Therefore, currently, a general idea is to directly use a LDA topic model for products purchased or browsed by the user on a website to obtain several interest topics, and then manually mark such part of the interest topics. Results obtained by directly using the LDA topic model have a high repetition rate and low effectiveness, and manual labeling and filtering work required in a later stage is very heavy.

Therefore, there is a need for a new method and device for determining an interest label of a user.

The above information disclosed in the background section is only for enhancing understanding of the background of the present disclosure, so it may include information that does not constitute prior art known to those of ordinary skill in the art.

### SUMMARY

The present disclosure provides a method and device for determining an interest label of a user.

Other features and advantages of the present disclosure will become apparent from the following detailed description, or partly be learned through the practice of the present disclosure.

According to a first aspect of the present disclosure, there is provided a method for determining an interest label of a user, including: obtaining word segmentation data by performing pre-processing on basic data; obtaining seed data by performing maximum frequent itemset identification on the word segmentation data; obtaining word vector data and word weight data by performing data training on the seed data; and determining the interest label of the user according to the word vector data and the word weight data.

In an exemplary embodiment of the present disclosure, the step of obtaining word segmentation data by performing pre-processing on basic data includes: generating the basic data from historical shopping data of the user; and generating the word segmentation data by performing word segmentation processing on the basic data.

In an exemplary embodiment of the present disclosure, the step of obtaining seed data by performing maximum frequent itemset identification on the word segmentation data includes: obtaining all combining data of the word segmentation data according to a predetermined condition; determining a frequent itemset of each piece of the combining data according to a number of orders; and obtaining the seed data by performing maximum frequent itemset calculation on the frequent itemset.

In an exemplary embodiment of the present disclosure, the step of obtaining seed data by performing maximum frequent itemset identification on the word segmentation data includes: obtaining the seed data by performing the maximum frequent itemset identification on the word segmentation data through a distributed computing architecture of a data warehouse.

In an exemplary embodiment of the present disclosure, performing the data training on the seed data includes: performing the data training on the seed data through a three-layer bayesian model.

In an exemplary embodiment of the present disclosure, the method further includes: obtaining purchasing data of the user according to historical data, wherein the purchasing data comprises a product-purchasing number and a purchased-product identification.

In an exemplary embodiment of the present disclosure, the step of determining the interest label of the user according to the word vector data and the word weight data includes: determining the word vector data and the word weight data of the user according to the purchasing data of the user; calculating an interest value of the user according to the word vector data and the word weight data of the user; and determining the interest label of the user according to the interest value.

In an exemplary embodiment of the present disclosure, the step of calculating an interest value of the user according to the word vector data and the word weight data of the user includes: Sum=(a*Q), where Sum is the interest value of the user, α is the product-purchasing number of the user, and Q is a word weight corresponding to a product.

In an exemplary embodiment of the present disclosure, the step of determining the interest label of the user according to the interest value further includes: determining whether the interest value is greater than a predetermined threshold; and determining the interest label corresponding to the interest value greater than the predetermined threshold as the interest label of the user.

In an exemplary embodiment of the present disclosure, the method further includes: promoting information according to the interest label of the user.

According to an aspect of the present disclosure, there is provided an apparatus for determining an interest label of a user, including: a basic module, configured to obtain word segmentation data by performing pre-processing on basic data; a seed module, configured to obtain seed data by performing maximum frequent itemset identification on the word segmentation data; a training module, configured to obtain word vector data and word weight data by performing data training on the seed data; and a label module, configured to determine the interest label of the user according to the word vector data and the word weight data.

According to an aspect of the present disclosure, there is provided an electronic device, including: one or more processors; and a storage device, configured to store one or more programs. The one or more programs when the being executed by the one or more processors cause the one or more processors to implement the method described above.

According to an aspect of the present disclosure, there is provided a computer-readable medium, storing a computer program thereon. When the computer program is executed by a processor, the method described above is implemented.

It is to be understood that the above general description and the following detailed description are only to be illustrate and do not intend to limit the present disclosure.

### BRIEF DESCRIPTION OF THE DRAWINGS

FIG. 1 is a system architecture of a method for determining an interest label of a user according to an exemplary embodiment.

FIG. 2 is a flow chart showing a method for determining an interest label of a user according to an exemplary embodiment.

FIG. 3 is a schematic diagram showing a method for determining an interest label of a user according to an exemplary embodiment.

FIG. 4 is a schematic diagram showing a method for determining an interest label of a user according to another exemplary embodiment.

FIG. 5 is a flow chart showing a method for determining an interest label of a user according to another exemplary embodiment.

FIG. 6 is a schematic diagram illustrating a method for determining an interest label of a user according to an exemplary embodiment.

FIG. 7 is a schematic diagram showing a method for determining an interest label of a user according to another exemplary embodiment.

FIG. 8 is a schematic diagram showing a method for determining an interest label of a user according to an exemplary embodiment.

FIG. 9 is a schematic diagram showing a method for determining an interest label of a user according to another exemplary embodiment.

FIG. 10 is a flow chart showing a method for determining an interest label of a user according to another exemplary embodiment.

FIG. 11 is a block diagram showing an apparatus for determining an interest label of a user according to an exemplary embodiment.

FIG. 12 is a block diagram showing an electronic device according to an exemplary embodiment.

FIG. 13 is a schematic diagram showing a computer-readable medium according to an exemplary embodiment.

### DETAILED DESCRIPTION

Example embodiments will now be described more fully with reference to the drawings. However, the example embodiments may be implemented in various forms, and should not be construed as being limited to the embodiments set forth herein; on the contrary, these embodiments are provided so that the present disclosure is comprehensive and complete and fully convey the idea of the exemplary embodiments to those skilled in the art. The same reference numerals in the drawings denote the same or similar parts, and thus their repeated description will be omitted.

Furthermore, the described features, structures or characteristics may be combined in one or more embodiments in any suitable manner. In the following description, many specific details are provided to give a full understanding of the embodiments of the present disclosure. However, those skilled in the art will realize that technical solutions of the present disclosure may be practiced without one or more of the specific details, or other methods, components, devices, steps, etc. may be used. In other instances, well-known methods, devices, implementations, or operations have not been shown or described in detail to avoid obscuring aspects of the present disclosure.

The block diagrams shown in the drawings are merely functional entities and do not necessarily have to correspond to physically independent entities. That is, these functional entities may be implemented in the form of software, or implemented in one or more hardware modules or integrated circuits, or implemented in different networks and/or processor devices and/or microcontroller devices.

The flowchart shown in the drawings is only an exemplary description, and it is not necessary to include all contents and operations/steps, nor to be executed in the order described. For example, some operations/steps may also be decomposed, and some operations/steps may be merged or partially merged, so the order of actual execution may be changed according to an actual situation.

It should be understood that although the terms first, second, third, etc. may be used herein to describe various components, these components should not be limited by these terms. These terms are used to distinguish one component from another component. Therefore, a first component discussed below may be referred to as a second component without departing from the teachings of the concepts of the present disclosure. As used herein, the term “and/or” includes any and all combinations of one or more of the associated listed items.

Those skilled in the art may understand that the drawings are only schematic diagrams of example embodiments, and modules or processes in the drawings are not necessarily required to implement the present disclosure, and therefore cannot be used to limit the protection scope of the present disclosure.

The exemplary embodiments of the present disclosure will be described in detail below with reference to the drawings.

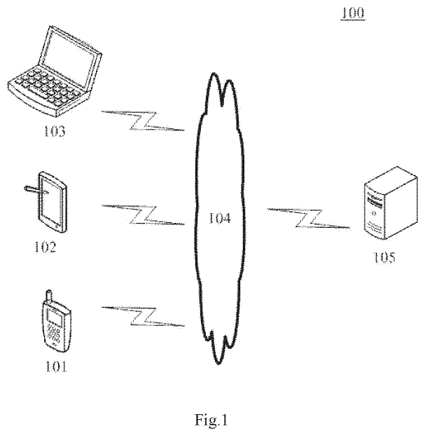

FIG. 1 is a system architecture showing a method for determining an interest label of a user according to an exemplary embodiment.

As shown in FIG. 1, a system architecture 100 may include terminal devices 101, 102 and 103, a network 104, and a server 105. The network 104 is a medium used to provide a communication link between the terminal devices 101, 102 and 103 and the server 105. The network 104 may include various connection types, such as wired, wireless communication links, or fiber optic cables, and so on.

A user may use the terminal devices 101, 102 and 103 to interact with the server 105 through the network 104 to receive or send messages, and so on. Various communication client applications, such as shopping applications, web browser applications, search applications, instant communication tools, email clients, and social platform software, may be installed on the terminal devices 101, 102 and 103.

The terminal devices 101, 102 and 103 may be various electronic devices having a display screen and supporting web browsing, including but not limited to smart phones, tablet computers, laptop portable computers, desktop computers, and so on.

The server 105 may be a server that provides various services, for example, a background management server that supports a shopping website browsed by users using the terminal devices 101, 102 and 103. The background management server may analyze and process received product information query request and other data, and feed back processing results (such as push information and product information) to the terminal device.

It should be noted that a method for generating a promoting message provided by embodiments of the present disclosure is generally executed by the server 105, and accordingly, a display page of the promoting message is generally set in the client 101.

It should be understood that the numbers of terminal devices, networks, and servers in FIG. 1 are only schematic. According to implementations, there may be any number of terminal devices, networks and servers.

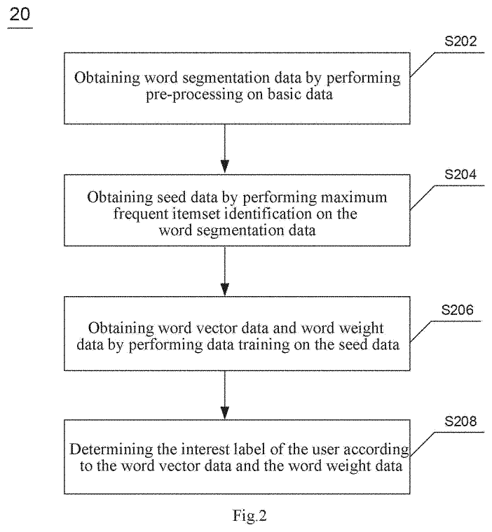

FIG. 2 is a flow chart showing a method for determining an interest label of a user according to an exemplary embodiment.

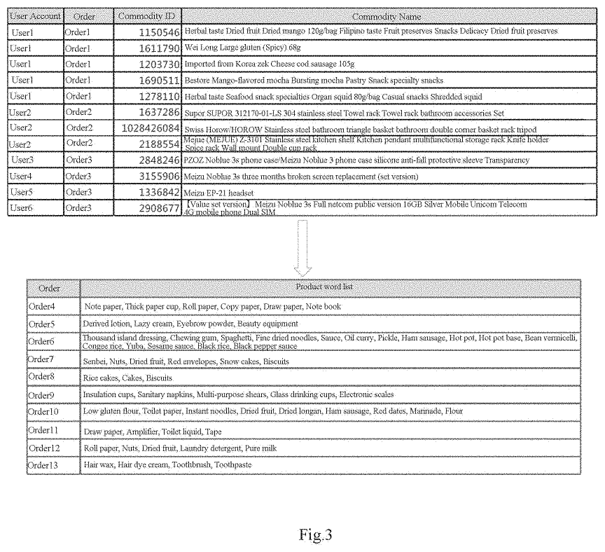

As shown in FIG. 2, in S202, word segmentation data is obtained by performing pre-processing on basic data. For example, the basic data may be generated from historical shopping data of the user; and the word segmentation data may be obtained by performing a word segmentation processing on the basic data. In an actual scenario, a shopping behavior of the user on a website at a time or in a period of time is all around a certain purpose or hobby. In this embodiment, for example, it may be assumed that each time that the user places an order is around a certain interest, and one-year shopping history data of the user is extracted from a data warehouse as the basic data. The basic data may be stored as one line in form of (user account+order+commodity id+commodity name). For example, it may process product words of the commodity in the basic data by using a word segmentation method, combine the product words of the same order into a product word list, and store the product words separated by a comma. The data at this time is the word segmentation data, and a data form thereof may be, for example, a form of order+product word list. A basic data format and the word segmentation data may be shown in FIG. 3, for example.

In S204, seed data is obtained by performing maximum frequent itemset identification on the word segmentation data. A set of items is called as an itemset. The itemset containing k items is called as a k-itemset, and the set {computer, ativirus_software} is a two-itemset. An item frequency of the itemset is a number of transactions that contain the itemset, referred to as an itemset frequency, support count or count. It should be noted that a support of a defined itemset is sometimes called as a relative support, and an occurrence frequency is called as an absolute support. If the relative support of an itemset I meets a predefined minimum support threshold, the itemset I is a frequent itemset. A maximum frequent itemset means that if all supersets of a frequent itemset L are infrequent itemsets, the frequent itemset L is called as the maximum frequent itemset or a maximum frequent pattern, and is denoted as MFI. The frequent itemset is a subset of the maximum frequent itemset. The maximum frequent itemset contains frequent information of the frequent itemset, and a size of a general itemset is several orders of magnitude smaller than that of the maximum frequent itemset. Therefore, it is a very effective method to mine the maximum frequent itemsets when a data set contains a long frequent pattern. For example, the seed data is obtained by performing the maximum frequent itemset identification on the word segmentation data through a distributed computing architecture of a data warehouse.

In S206, word vector data and word weight data are obtained by performing data training on the seed data. For example, the data training may be performed on the seed data through a three-layer bayesian model. A LDA (Latent Dirichlet Allocation) is a document topic generating model, also known as a three-layer bayesian probability model, which contains a three-layer structure of words, topics and documents. The so-called generating model means that each word of an article is obtained through a process of “selecting a certain topic with a certain probability and selecting a certain word from this topic with a certain probability”. Documents to topics follow a polynomial distribution, and topics to words follow a polynomial distribution. Through the LDA model training, for example, the complete word vector and the weight of each word in the seed data may be obtained.

In S208, the interest label of the user is determined according to the word vector data and the word weight data. For each user, all product words and product word weights of the user under a certain category may be obtained from the word vectors and word weights. Comprehensively considering all the product words and product word weights of the user under the certain category (which can be, for example, the product of the product word and the corresponding product word weight), an interest score of the user may be obtained. For example, it may be determined whether an interest value is greater than a predetermined threshold; and the interest label corresponding to the interest value greater than the predetermined threshold is determined as the interest label of the user.

According to the method for determining an interest label of a user of the present disclosure, a word segmentation representation is performed on original data, a training is performed on word segmentation is by using a three-layer bayesian network to obtain word vectors and word weights, and then an interest score is determined, so that an interest label is allocated to the user, which can effectively determine an interest topics of the user and reduce a manual processing time.

It should be clearly understood that the present disclosure describes forming and using specific examples, but the principle of the present disclosure is not limited to any details of these examples. Rather, based on the teachings of the present disclosure, these principles may be applied to many other embodiments.

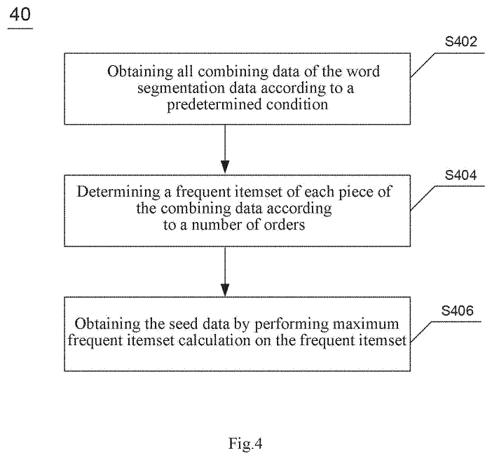

FIG. 4 is a flow chart showing a method for determining an interest label of a user according to another exemplary embodiment. Since data volume is large, there will be problems such as too long computing time or insufficient storage for calculating when directly using an association algorithm such as an FP-growth method to find the frequent itemset. Herein, map-reduce may be written to implement such method through a distributed computing architecture of a data warehouse. FIG. 4 is an exemplary description of obtaining seed data from word segmentation data.

As shown in FIG. 4, in S402, all combining data of the word segmentation data is obtained according to a predetermined condition. In this embodiment, it is based on the following: 3 or less words are not enough to locate the interest and hobby of the user, and if there are too many words (for example, more than 15 words), the interest of the user in this order is complicated, which may cause subsequent excessive calculations; for example, a product word list of an order with product words greater than 3 and less than 15 may be selected for the subsequent calculations; for the product word list of each order, all combinations with a word number greater than 3 may be obtained (this step may be achieved, for example, by map-reduce). For example, for the combination (note paper, thick paper cup, roll paper, copy paper, draw paper, note book), the number of combination results with the word number greater than 3 is as follows: C₆⁴+C₆⁵+C₆⁶=22.

In S404, a frequent itemset of each piece of the combining data is determined according to a number of orders. For example, the combination of the product with the number of orders greater than a predetermined threshold is the frequent itemset.

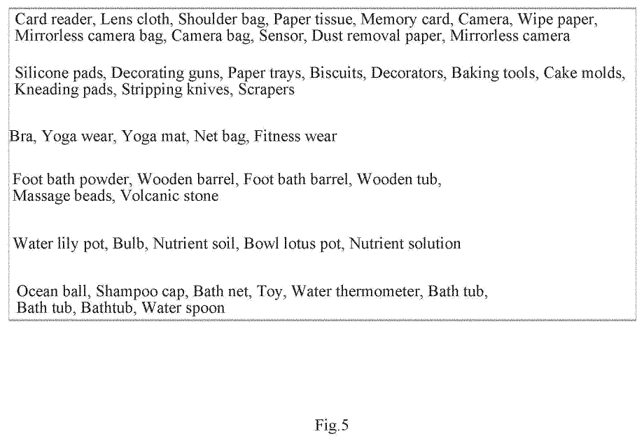

In S406, the seed data is obtained by performing maximum frequent itemset calculation on the frequent itemset. The maximum frequent itemset is obtained by performing calculating on the frequent itemset of the previous step, and the data in the maximum frequent itemset is used as the seed data. The seed data results are shown in FIG. 5.

According to the method for determining an interest label of a user of the present disclosure, seed data is obtained according to a frequent itemset, and then the seed data is used as an input of LDA calculation, which may obtain a high-quality interest subject and reduce a manual processing time.

In an exemplary embodiment of the present disclosure, it further includes: obtaining purchasing data of the user according to historical data. The purchasing data includes a product-purchasing number and a purchased-product identification.

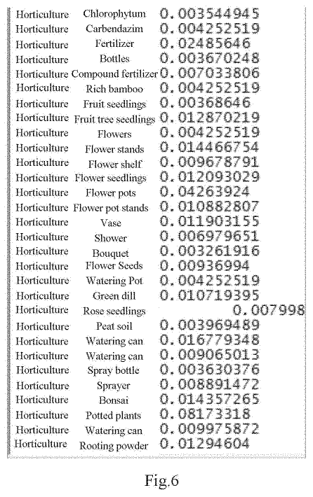

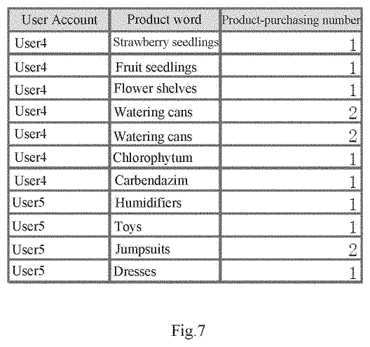

FIGS. 6 and 7 are schematic diagrams showing a method for determining an interest label of a user according to an exemplary embodiment.

In an exemplary embodiment of the present disclosure, the determining the interest label of the user according to the word vector data and the word weight data includes: determining the word vector data and the word weight data of the user according to the purchasing data of the user; calculating an interest value of the user according to the word vector data and the word weight data of the user; and determining the interest label of the user according to the interest value. It performs training by using each maximum frequent itemset as the seed word of the LDA topic model to obtain a more complete word vector and the weight of each word under the interest. FIG. 6 shows (topic+word+word weight). It calculates the products purchased by all users in a period of time and the purchasing number of each product, as shown in FIG. 7. (user account+product word+product purchasing number).

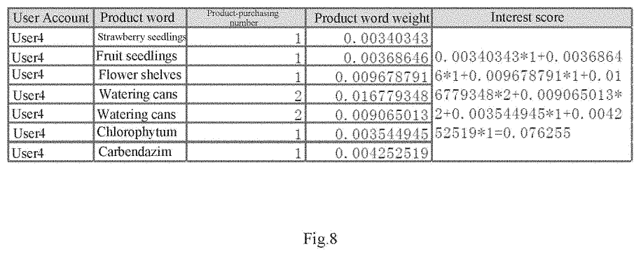

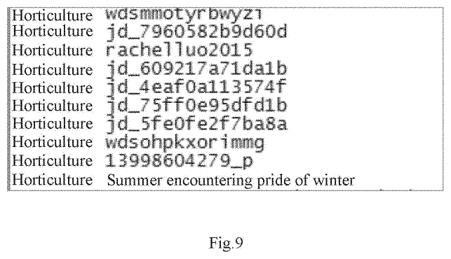

FIGS. 8 and 9 are schematic diagrams showing a method for determining an interest label of a user according to an exemplary embodiment.

In an exemplary embodiment of the present disclosure, the calculating the interest value of the user according to the word vector data and the word weight data of the user includes:

Sum=(a*Q)

where Sum is the interest value of the user, α is the product-purchasing number of the user, and Q is a word weight corresponding to a product. It further comprises: determining whether the interest value is greater than a predetermined threshold; and determining the interest label corresponding to the interest value greater than the predetermined threshold as the interest label of the user. For each user, it may obtain the interest and product word weight to which each product word belongs. As shown in the following figure, all product words and product word weights of user 4 under horticulture may be obtained. For example, sum (the number of product purchasing*the product word weight) is the score of horticulture interest. The score is shown in FIG. 8. When the user's interest score is greater than a certain threshold, the user is tagged with corresponding interest label, and the result is shown in FIG. 9 (topic, account).

In an exemplary embodiment of the present disclosure, the method further includes: promoting information according to the interest label of the user.

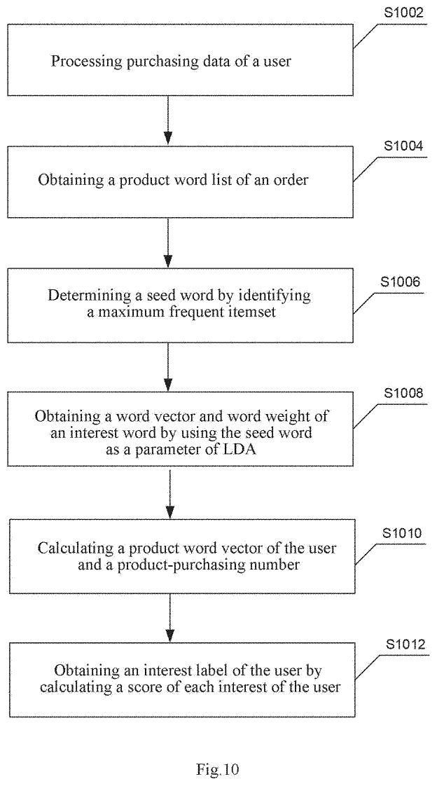

FIG. 10 is a flow chart showing a method for determining an interest label of a user according to another exemplary embodiment.

In S1002, purchasing data of a user is processed.

In S1004, a product word list of an order is obtained.

In S1006, a seed word is determined by identifying a maximum frequent itemset.

In S1008, a word vector and word weight of an interest word is obtained by using the seed word as a parameter of LDA.

In S1010, a product word vector of the user and a product-purchasing number are calculated.

In S1012, an interest label of the user is obtained by calculating a score of each interest of the user.

Shopping data of the user on an e-commerce website is obtained. Firstly, the interest of the user is initially located by using a frequent itemset method to obtain the seed word, and then the seed word is used as the input of the LDA to obtain the product word vector that can more fully characterize the interest. The product word vector of interest is compared with the product word vector of the user, and the user who meets certain conditions is tagged with the corresponding interest label.

Those skilled in the art may understand that all or part of the steps for implementing the above-described embodiments are implemented as computer programs executed by a CPU. When the computer program is executed by the CPU, the above function defined by the above method provided by the present disclosure is executed. The program may be stored in a computer-readable storage medium, and the storage medium may be a read-only memory, a magnetic disk, or an optical disk.

In addition, it should be noted that the above drawings are only schematic illustrations of processes included in the method according to the exemplary embodiments of the present disclosure, and are not for limiting. It is easy to understand that the processes shown in the above drawings do not indicate or limit a chronological order of these processes. In addition, it is also easy to understand that these processes may be performed synchronously or asynchronously in multiple modules, for example.

The following is a device embodiment of the present disclosure, which can be used to execute the method embodiment of the present disclosure. For details not disclosed in the device embodiments of the present disclosure, please refer to the method embodiments of the present disclosure.

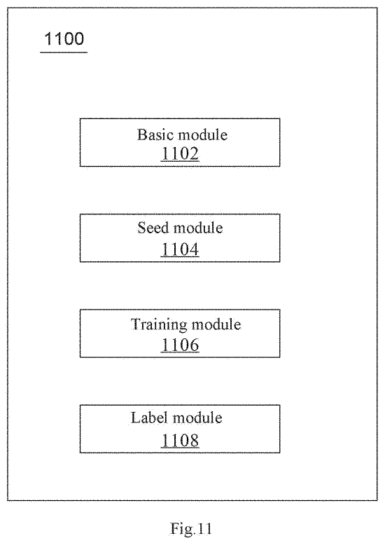

FIG. 11 is a block diagram showing an apparatus for determining an interest label of a user according to an exemplary embodiment.

A basic module 1102 is configured to obtain word segmentation data by performing pre-processing on basic data.

A seed module 1104 is configured to obtain seed data by performing maximum frequent itemset identification on the word segmentation data.

A training module 1106 is configured to obtain word vector data and word weight data by performing data training on the seed data.

A label module 1108 is configured to determine the interest label of the user according to the word vector data and the word weight data.

According to the apparatus for determining an interest label of a user of the present disclosure, a word segmentation representation is performed on original data, a training is performed on word segmentation data is by using a three-layer bayesian network to obtain word vectors and word weights, and then an interest score of the user is determined, so that an interest label is allocated to the user, which can effectively determine an interest topics of the user and reduce a manual processing time.

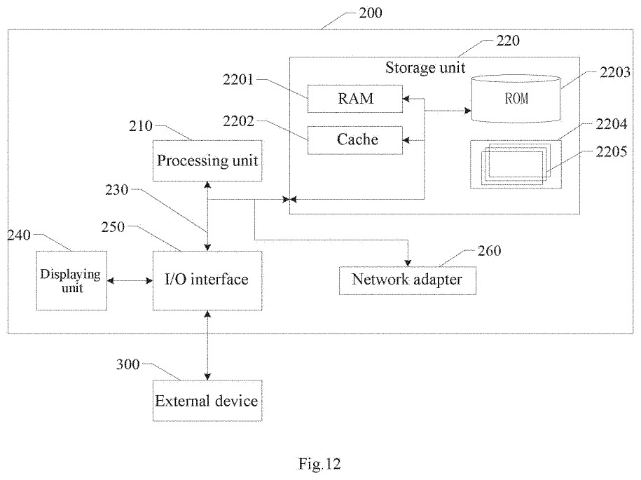

FIG. 12 is a block diagram of an electronic device according to an exemplary embodiment.

An electronic device 200 according to the embodiment of the present disclosure will be described below with reference to FIG. 12. The electronic device 200 shown in FIG. 12 is only an example, and should not limit the function and use scope of the embodiments of the present disclosure.

As shown in FIG. 12, the electronic device 200 is represented in the form of a general-purpose computing device. Components of the electronic device 200 may include, but are not limited to: at least one processing unit 210, at least one storage unit 220, a bus 230 connecting different system components (including the storage unit 220 and the processing unit 210), a displaying unit 240, and the like.

The storage unit stores a program code, and the program code may be executed by the processing unit 210, so that the processing unit 210 executes the steps described in the above method for determining an interest label of a user in the specification according to various exemplary embodiments of the present disclosure. For example, the processing unit 210 may perform the steps shown in FIGS. 2 and 4.

The storage unit 220 may include a readable medium in the form of a volatile storage unit, such as a random access storage unit (RAM) 2201 and/or a cache storage unit 2202, and may further include a read-only storage unit (ROM) 2203.

The storage unit 220 may further include a program/utility tool 2204 having a set of (at least one) program modules 2205. Such program modules 2205 include but are not limited to an operating system, one or more application programs, other program modules, and program data, and each of these examples or some combination may include the implementation of the network environment.

The bus 230 may be one or more of several types of bus structures, including a storage unit bus or a storage unit controller, a peripheral bus, a graphics acceleration port, a processing unit, or a local area bus using any of a variety of bus structures.

The electronic device 200 may also communicate with one or more external devices 300 (such as a keyboard, pointing device, Bluetooth device, etc.), and may also communicate with one or more devices that enable a user to interact with the electronic device 200, and/or any device (e.g., a router, modem, etc.) that enables the electronic device 200 to communicate with one or more other computing devices. Such communication may be performed through an input/output (I/O) interface 250. Moreover, the electronic device 200 may also communicate with one or more networks (such as a local area network (LAN), a wide area network (WAN), and/or a public network, such as the Internet) through the network adapter 260. The network adapter 260 can communicate with other modules of the electronic device 200 through the bus 230. It should be understood that although not shown in the figure, other hardware and/or software modules may be used in conjunction with the electronic device 200, including but not limited to: a microcode, device driver, redundant processing unit, external disk drive array, RAID system, tape driver, data backup storage system and the like.

Through the description of the above embodiments, those skilled in the art can easily understand that the example embodiments described herein can be implemented by software, or can be implemented by software in combination with necessary hardware. Therefore, the technical solution according to the embodiments of the present disclosure may be embodied in the form of a software product, which may be stored in a non-volatile storage medium (which may be a CD-ROM, U disk, mobile hard disk, etc.) or on a network. The software product includes several instructions to make one computing device (which may be a personal computer, server, or network device, etc.) execute the above-mentioned method for determining an interest label of a user according to the embodiment of the present disclosure.

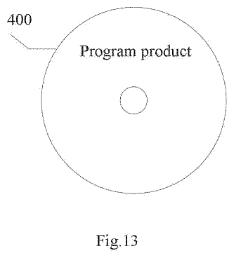

FIG. 13 is a schematic diagram of a computer-readable medium according to an exemplary embodiment.

Referring to FIG. 13, a program product 400 for implementing the above method according to an embodiment of the present disclosure is described. For example, the program product 400 may take a form of portable compact disk read only memory (CD-ROM) and include program codes, and may be executed on a terminal device, for example, a personal computer. However, the program product of the present disclosure is not limited thereto. In this text, the readable storage medium may be any tangible medium that contains or stores a program, and the program may be used by or in combination with an instruction execution system, apparatus, or device.

The program product may employ any combination of one or more readable medium. The readable medium may be a readable signal medium or a readable storage medium. The readable storage medium may be but not limited to, for example, an electrical, magnetic, optical, electromagnetic, infrared, or semiconductor system, device, or element, or any combination of the above. More specific examples of readable storage medium (non-exhaustive list) include: electrical connections with one or more wires, portable disks, hard disks, random access memory (RAM), read only memory (ROM), erasable programmable read-only memory (EPROM or flash memory), optical fiber, portable compact disk read-only memory (CD-ROM), optical storage device, magnetic storage device, or any suitable combination of the foregoing.

The computer-readable storage medium may include a data signal propagated in baseband or as part of a carrier wave, in which readable program codes are carried. This propagated data signal can take many forms, including but not limited to electromagnetic signals, optical signals, or any suitable combination of the above. The readable storage medium may also be any readable medium other than the readable storage medium, and the readable medium may send, propagate, or transmit a program for use by or in combination with the instruction execution system, apparatus, or device. The program code contained on the readable storage medium may be transmitted using any appropriate medium, including but not limited to wireless, wired, optical fiber cable, RF, etc., or any suitable combination of the foregoing.

The program code for performing the operations of the present invention can be written in any combination of one or more programming languages, including object-oriented programming languages such as Java, C++, etc., as well as conventional procedural programming languages such as “C” language or similar programming language. The program code may be executed entirely on the user's computing device, partly on the user's device, as an independent software package, partly on the user's computing device and partly on a remote computing device, or entirely on the remote computing device or server. In situations involving remote computing devices, the remote computing device may be connected to the user computing device through any kind of network, including a local area network (LAN) or a wide area network (WAN), or may be connected (for example, via the internet by using an Internet service provider) to an external computing device.

The computer-readable medium carries one or more programs. When the one or more programs are executed by the device, the computer-readable medium realizes the following functions: obtaining word segmentation data by performing pre-processing on basic data; obtaining seed data by performing maximum frequent itemset identification on the word segmentation data; obtaining word vector data and word weight data by performing data training on the seed data; and determining the interest label of the user according to the word vector data and the word weight data.

Those skilled in the art may understand that the above modules may be distributed in the device according to the description of the embodiment, or may be changed accordingly to be different from that in one or more devices of the embodiment. The modules in the above embodiments may be combined into one module, or may be further split into multiple sub-modules.

Through the description of the above embodiments, those skilled in the art can easily understand that the example embodiments described herein can be implemented by software, or can be implemented by software in combination with necessary hardware. Therefore, the technical solution according to the embodiment of the present disclosure can be embodied in the form of a software product, which can be stored in a non-volatile storage medium (which can be a CD-ROM, U disk, mobile hard disk, etc.) or on the network. The software product includes several instructions to enable a computing device (which may be a personal computer, server, mobile terminal, or network device, etc.) to execute the method according to an embodiment of the present disclosure.

In addition, the structure, ratio, size, etc. shown in the drawings of this specification are only used to describe the content disclosed in the specification for the understanding and reading of those skilled in the art, and are not to define the conditions in which the present disclosure can be implemented. Therefore, any modification of structure, change of proportion or adjustment of size with no substantial technical sense shall still fall within the scope of the present disclosure without affecting the technical effects and objectives that can be achieved by the present disclosure. At the same time, the terms such as “on”, “first”, “second” and “a/an” cited in this specification are only for the convenience of description, not to limit the scope of the present disclosure, and changes or adjustments in the relative relationship are considered to be within the scope of the present disclosure with no substantial technical changes.

1. A method for determining an interest label of a user, comprising:
obtaining word segmentation data by performing pre-processing on basic data;
obtaining seed data by performing maximum frequent itemset identification on the word segmentation data;
obtaining word vector data and word weight data by performing data training on the seed data; and
determining the interest label of the user according to the word vector data and the word weight data.

2. The method according to claim 1, wherein the step of obtaining word segmentation data by performing pre-processing on basic data comprises:
generating the basic data from historical shopping data of the user; and
generating the word segmentation data by performing word segmentation processing on the basic data.

3. The method according to claim 1, wherein the step of obtaining seed data by performing maximum frequent itemset identification on the word segmentation data comprises:
obtaining all combining data of the word segmentation data according to a predetermined condition;
determining a frequent itemset of each piece of the combining data according to a number of orders; and
obtaining the seed data by performing maximum frequent itemset calculation on the frequent itemset.

4. The method according to claim 1, wherein the step of obtaining seed data by performing maximum frequent itemset identification on the word segmentation data comprises:
obtaining the seed data by performing the maximum frequent itemset identification on the word segmentation data through a distributed computing architecture of a data warehouse.

5. The method according to claim 1, wherein performing the data training on the seed data comprises:
performing the data training on the seed data through a three-layer bayesian model.

6. The method of claim 1, further comprising:
obtaining purchasing data of the user according to historical data,
wherein the purchasing data comprises a product-purchasing number and a purchased-product identification.

7. The method according to claim 6, wherein the step of determining the interest label of the user according to the word vector data and the word weight data comprises:
determining the word vector data and the word weight data of the user according to the purchasing data of the user;
calculating an interest value of the user according to the word vector data and the word weight data of the user; and
determining the interest label of the user according to the interest value.

8. The method according to claim 7, wherein the step of calculating an interest value of the user according to the word vector data and the word weight data of the user comprises:
Sum=(a*Q)
where Sum is the interest value of the user, α is the product-purchasing number of the user, and Q is a word weight corresponding to a product.

9. The method of claim 7, wherein the step of determining the interest label of the user according to the interest value further comprises:
determining whether the interest value is greater than a predetermined threshold; and
determining the interest label corresponding to the interest value greater than the predetermined threshold as the interest label of the user.

10. The method of claim 1, further comprising:
promoting information according to the interest label of the user.

11. (canceled)

12. An electronic device, comprising:
one or more processors;
a storage device, configured to store one or more programs;
wherein the one or more programs when the being executed by the one or more processors cause the one or more processors to implement a method for determining an interest label of a user, comprising:
obtaining word segmentation data by performing pre-processing on basic data;
obtaining seed data by performing maximum frequent itemset identification on the word segmentation data;
obtaining word vector data and word weight data by performing data training on the seed data, and
determining the interest label of the user according to the word vector data and the word weight data.

13. A computer-readable medium, storing a computer program thereon, wherein when the computer program is executed by a processor, a method for determining an interest label of a user is implemented, wherein the method comprises:
obtaining word segmentation data by performing pre-processing on basic data;
obtaining seed data by performing maximum frequent itemset identification on the word segmentation data;
obtaining word vector data and word weight data by performing data training on the seed data; and
determining the interest label of the user according to the word vector data and the word weight data.

14. The electronic device according to claim 12, wherein the step of obtaining word segmentation data by performing pre-processing on basic data comprises:
generating the basic data from historical shopping data of the user; and
generating the word segmentation data by performing word segmentation processing on the basic data.

15. The electronic device according to claim 12, wherein the step of obtaining seed data by performing maximum frequent itemset identification on the word segmentation data comprises:
obtaining all combining data of the word segmentation data according to a predetermined condition;
determining a frequent itemset of each piece of the combining data according to a number of orders; and
obtaining the seed data by performing maximum frequent itemset calculation on the frequent itemset.

16. The electronic device according to claim 12, wherein the step of obtaining seed data by performing maximum frequent itemset identification on the word segmentation data comprises:
obtaining the seed data by performing the maximum frequent itemset identification on the word segmentation data through a distributed computing architecture of a data warehouse.

17. The electronic device according to claim 12, wherein performing the data training on the seed data comprises:
performing the data training on the seed data through a three-layer bayesian model.

18. The electronic device of claim 12, wherein the method further comprises:
obtaining purchasing data of the user according to historical data,
wherein the purchasing data comprises a product-purchasing number and a purchased-product identification.

19. The electronic device according to claim 18, wherein the step of determining the interest label of the user according to the word vector data and the word weight data comprises:
determining the word vector data and the word weight data of the user according to the purchasing data of the user;
calculating an interest value of the user according to the word vector data and the word weight data of the user; and
determining the interest label of the user according to the interest value.

20. The electronic device according to claim 19, wherein the step of calculating an interest value of the user according to the word vector data and the word weight data of the user comprises:
Sum=(a*Q)
where Sum is the interest value of the user, α is the product-purchasing number of the user, and Q is a word weight corresponding to a product.

21. The electronic device of claim 19, wherein the step of determining the interest label of the user according to the interest value further comprises:
determining whether the interest value is greater than a predetermined threshold; and
determining the interest label corresponding to the interest value greater than the predetermined threshold as the interest label of the user.
